(19) United States
(12) Patent Application Publication
(10) Pub. No.: US 2017/0212968 A1
(43) Pub. Date: Jul. 27, 2017

(54) Circuit Verification

(71) Applicant: Easy-Logic Technology Limited, Hong Kong (CN)

(72) Inventors: Yi DIAO, Hong Kong (CN); Xing WEI, Hong Kong (CN); Yu-Liang WU, Hong Kong (CN)

(21) Appl. No.: 15/405,328

(22) Filed: Jan. 13, 2017

Related U.S. Application Data
(60) Provisional application No. 62/281,735, filed on Jan. 22, 2016.

(51) Int. Cl. G06F 17/50; G06F 7/57

(52) U.S. Cl. CPC G06F 17/504; G06F 7/57

(57) ABSTRACT

A method enables arithmetic circuit verification with improved runtime complexity by coupling reverse engineering and a SAT solver together. The method provides a netlist f of a first arithmetic circuit and a netlist g of a second arithmetic circuit; and improves the runtime complexity by conducting equivalence checking between the netlist f and the netlist g such that structural difference between the netlist f and the netlist g is minimized by reverse engineering before generating a conjunctive normal form (CNF) encoding that is solved by a satisfiability (SAT) solver such that the arithmetic circuit verification is completed in polynomial time rather than in exponential time.

### CLAIM OF BENEFIT TO PRIOR APPLICATION

This application claims benefit to U.S. Provisional Patent Application 62/281,735, entitled “Tai-Chi Coupling Optimization Method: Coupling Reverse Engineering and SAT to Tackle NP-Complete Arithmetic Circuitry Verification”, filed on Jan. 22, 2016, the content of which is incorporated herein by reference in its entirety.

### FIELD OF THE INVENTION

The present invention generally relates to methods and apparatus that provide circuit verification.

### BACKGROUND

Over the last several decades, complexity of arithmetic circuits such as integrated circuits (IC) has increased significantly. In a typical design process, it is often the case that over 60% of overall design time is spent in one or more verification processes. Verification methods are basically classified into two categories: simulation based and formal method based. The simulation based method is not a complete verification method and is only used as a last-resort choice when a formal method cannot do the required verification job. Only the formal method can guarantee a complete verification result however the formal verification problem is known to be NP-Complete which would take an exponential run time particularly in arithmetic circuitry part verifications if using today's known formal verification algorithms. Thus the conventional formal verification method can only be practical for smaller circuits. Since today's IC design can include millions of tiny electronic components, such as gates or transistors, it is impossible for the current formal method to complete the verification processes.

New methods and apparatus are desired if it is expected to achieve a formal verification task for today's arithmetic circuits under a small (non-exponential) run time.

### SUMMARY OF THE INVENTION

One example embodiment provides a new formal method which couples (combines) satisfiability (SAT) solver and a unique Reverse Engineering (RE) method which makes use the knowledge of the arithmetic component structure properties (e.g. 1-bit adder structure, Carry tree structure) to achieve the formal verification task for arithmetic circuits regardless of its size.

The example embodiment provides a method to enable arithmetic circuit verification with improved runtime complexity over conventional methods. The method provides a netlist f of a first arithmetic circuit and a netlist g of a second arithmetic circuit; and improves the runtime complexity by conducting equivalence checking between the netlist f and the netlist g such that structural difference between the netlist f and the netlist g is minimized before generating a conjunctive normal form (CNF) encoding that is solved by a satisfiability (SAT) solver such that the arithmetic circuit verification is completed in polynomial time rather than in exponential time.

Example embodiments work in a complementary way (or Complementary Greedy Coupling (CGC) approach, or Tai-Chi Coupling) of coupling reverse engineering (RE) technology and a SAT solver together efficiently for equivalence checking. Efficiency of circuit verification is significantly improved such that a much shorter time is required to complete the verification. Circuit verification that cannot be performed by a SAT solver alone (such as arithmetic circuits) can be executed fast by example embodiments.

Other example embodiments are discussed herein.

### BRIEF DESCRIPTION OF THE DRAWINGS

FIGS. 1A shows a graph illustrating a 4×4 Booth multiplier in accordance with an example embodiment.

FIGS. 1B shows a graph illustrating a Non-Booth Wallace tree multiplier in accordance with an example embodiment.

FIGS. 2A shows a graph illustrating a macro in accordance with an example embodiment.

FIGS. 2B shows a graph illustrating a macro in accordance with an example embodiment.

FIG. 3 shows a graph illustrating equivalence checking in accordance with an example embodiment.

FIG. 4 shows a flow diagram illustrating an example method in accordance with an example embodiment.

FIGS. 5A shows two netlists before normalization in accordance with an example embodiment.

FIGS. 5B shows two netlists after normalization in accordance with an example embodiment.

FIG. 6 shows a flow diagram illustrating an example method in accordance with an example embodiment.

FIGS. 7A shows a graph illustrating an implementation in accordance with an example embodiment.

FIGS. 7B shows a graph illustrating an implementation in accordance with an example embodiment.

FIG. 8 shows a table illustrating characteristics of benchmarks in accordance with an example embodiment.

FIG. 9 shows a graph illustrating comparison between example methods and existing methods in accordance with an example embodiment.

FIG. 10 shows a table illustrating comparison between example methods and two existing commercial tools in accordance with an example embodiment.

FIG. 11 shows a computer system in accordance with an example embodiment.

### DETAILED DESCRIPTION

Example embodiments relate to methods and apparatus that improve arithmetic circuit verification.

Circuit or circuitry verification is an essential step in integrated circuit (IC) design and fabrication. Such verification processes are estimated to account for over 60% of overall design time. A modern IC typically includes millions of miniscule electronic components, such as gates and transistors, which makes it impossible for a person to perform circuit verification mentally or manually with a pencil and paper. Hardware, such as a computer device or system that incorporates or embeds software (such as Electronic design automation (EDA) tools) is generally employed to complete such tasks.

Effectiveness and efficiency have great importance for circuit verification in circuit industry such as the IC industry. Undetected flaws in an IC during verification process can make the circuit worthless. Low efficiency (such as high runtime or time complexity) lengthens design cycles and increases time-to-market and jeopardizes profit margins. Furthermore, unsatisfactory efficiency or runtime complexity requires more resource usage (such as memory usage), high performance (such as high processing capacity and speed) for a computer device. Thus, unsatisfactory methods or schemes for circuit verification not only jeopardize IC industry technologically and economically, but also require costly computer hardware by demanding large resource consumption such as memory usage and high processing speed.

Some formal verification tasks such as comparing two netlists implementing multipliers are also challenging as an NP-complete problem.

Existing or conventional methods that verify arithmetic circuit or circuitry are flawed in one or more aspects. For example, existing Ordered Binary Decision Diagram (OBDD) is known to be canonical for a Boolean function under a fixed variable ordering. When representing a multiplier in the OBDD, however, exponential memory is required regardless of variable orderings. Binary Moment Diagrams (BMDs) and Multiplicative Power Hybrid Decision Diagrams (PHDDs) are merely efficient for word-level operations, and are not efficient for representing Boolean logics. As another example, existing satisfiability (SAT) solvers highly rely on successfully locating of internal equivalent points of compared logics. When few internal equivalent points are found, even for a quite small circuit, the solving time or runtime grows exponentially in the worst cases such as when performing comparison between multipliers designed in different styles (e.g. non-Booth versus Booth). SAT solvers also show inability or inefficiency for arithmetic circuit verification, such as incapability in proving equality between two arithmetic circuits. Some other existing methods or algorithms require prior knowledge of input and output boundaries. In real industry, however, such knowledge is generally unknown because arithmetic macros are often hidden inside flatten netlists, which makes such existing techniques not useful in real industry.

As used herein, Reverse Engineering (RE) is a process of extracting design information from a gate level netlist. In example embodiments, reverse engineering is applied to extract arithmetic macros such as adders, multipliers, multiplexers (MUX) or a formula such as (A+B)×C for verification. By way of example, reverse engineering and SAT technique are coupled (combined) to conduct the equivalence checking.

By way of example, a macro or operator macro is defined to be a block of logic which is a building component in ICs such as adders, multipliers, multiplexers (MUX) or a formula such as (A+B)×C.

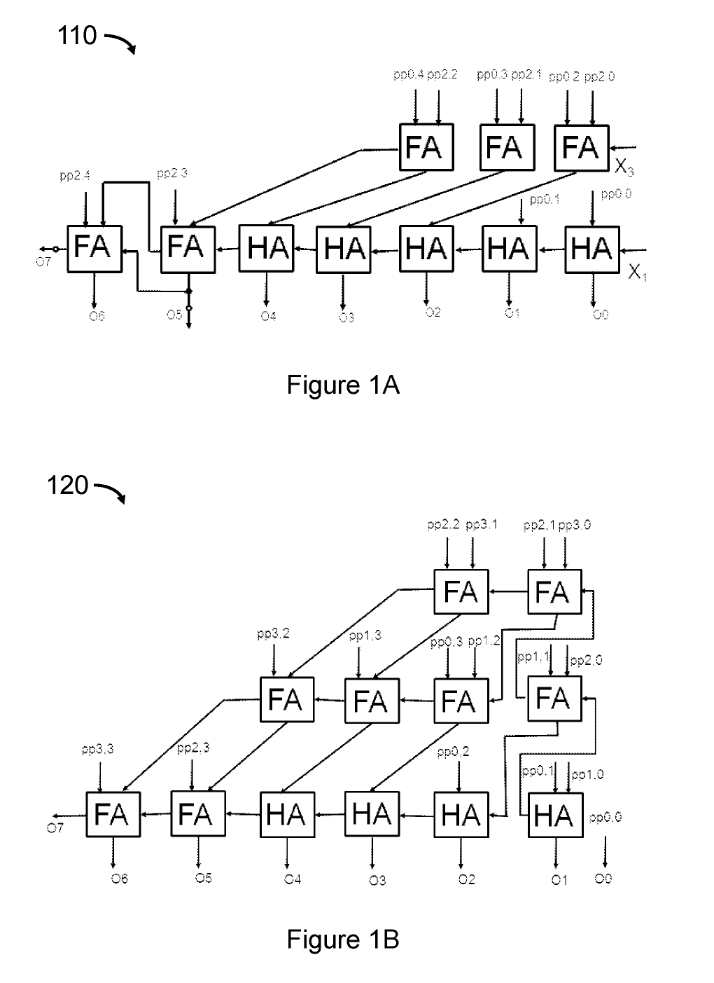

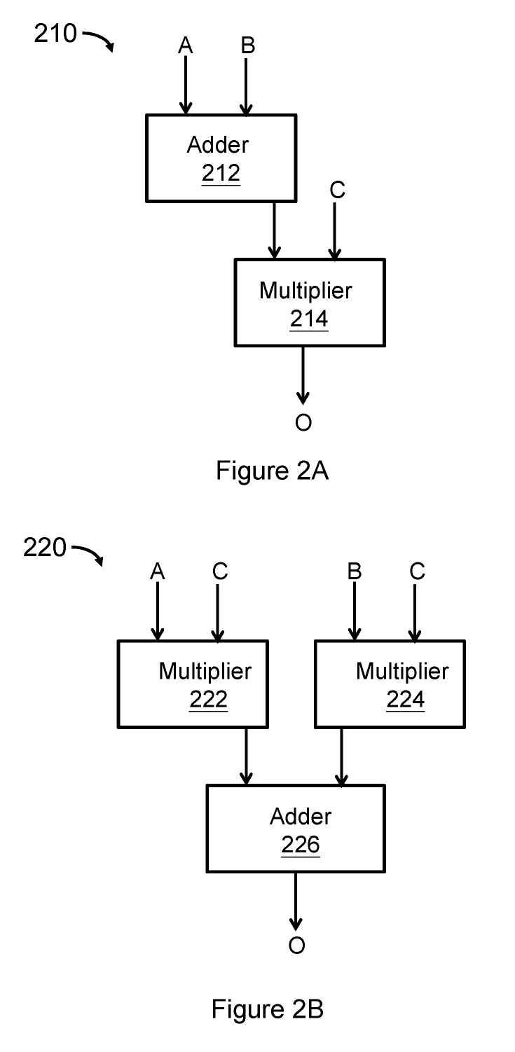

Macros, especially multipliers, generally bring great challenge to existing verification engines such as equivalence checkers. This is illustrated by FIGS. 1A-1B and FIGS. 2A-2B. As illustrated, FIGS. 1A-1B show two graphs in accordance with an example embodiment. The graph in FIG. 1A is an illustrative 4×4 Booth multiplier 110, and the graph in FIG. 1B is an illustrative 4×4 Non-Booth Wallace tree multiplier 120, wherein FA represents full adder and HA represents half adder. The Booth multiplier 110 and the Non-Booth Wallace tree multiplier 120 are functionally equivalent but are implemented in different styles.

FIGS. 2A-2B show two graphs in accordance with an example embodiment. The graph 210 in FIG. 2A includes an adder 212 with two inputs A and B. The output of the adder 212, together with another input C, is input of a multiplier 214 that has an output O. The graph 210 shows an implementation of (A+B)×C.

The graph 220 in FIG. 2B includes a multiplier 222 with input A and C, and a multi-plier 224 with input B and C. The outputs of the two multipliers are inputs of an adder 226 that has an output O. The graph 220 shows an implementation of A×C+B×C.

As illustrated, the implemented formulae or implementations in FIGS. 2A and 2B are equivalent functionally, but have different styles or formula structure. A direct equivalence checking by an existing SAT solver fails to complete within a practical time limit in this scenario.

For example, existing equivalence checkers perform well if the two designs (e.g. two netlists) include a high degree of structural similarity (e.g. high degree of internal equivalences). However, if no internal equivalence exists (e.g. no structural similarity or low degree of structural similarity), the existing equivalence checkers fail and verification becomes impossible even for relatively small circuits. For example, the complexity of verifying an un-satisfiable n-input exclusive-or (XOR)-tree (n-input XOR primitive) is O(2n) if no internal equivalence points can be found, wherein O( ) is a Big O notation that characterizes how runtime complexity or processing time changes as the problem size or input size becomes extremely large.

A partial product of a Booth multiplier is illustrated in Equation 1, while a partial product of a Non-Booth multiplier is illustrated in Equation 2 (each of aᵢ and bⱼ is an input bit of a multiplier operand). A direct equivalence checking by an existing SAT solver fails to complete within a practical time limit. It requires exponential time for a SAT solver to verify the equivalence of two m x n multipliers implemented in Booth and non-Booth Wallace trees respectively, which is less efficient and even impractical in real industry, and such problem is overcome by example embodiments.

pp_{i,j}=(aᵢ [symbol] aᵢ₋₁)(bⱼ [symbol] aᵢ₊₁)+ [symbol] (aᵢ [symbol] aᵢ₋₁)(aᵢ₊₁ [symbol] aᵢ)(bⱼ₋₁ [symbol] aᵢ₊₁) (1)

Example embodiments solve the above-stated problems by providing technical solutions in new methods and apparatus that improve or facilitate arithmetic circuit verification. Example embodiments benefit circuit industry such as IC industry by improving technology in circuit verification with enhanced effectiveness and efficiency, which improves circuit (such as IC, Application Specific Integrated Circuit (ASIC), and

Field-Programmable Gate array (FPGA), etc.) design technology and circuit production such as yield. Example embodiments further benefit computer technology by reducing resource consumption such as memory usage. Example methods can be executed by a computer device or system with lower requirement for hardware to perform circuit verification and thus mitigate demand of costly computers with expensive chips, memory and other internal electronic components.

Example embodiments includes a computer system with specific software incorporated, as well as such a computer system embedded in a network. Example computer system solves technical problems raised in circuit industry such as IC industry by executing example methods herein. When executing example methods, example computer system improves hardware performance by reducing resource usage such as memory usage.

By way of example, example embodiments solve the above-stated problems and/or overcome the inability of existing methods and devices in performing arithmetic circuitry verification by providing technical solutions in new methods and apparatus in which reverse engineering (RE) and SAT technique are coupled or combined.

Example reverse engineering performs well in verification or proof of equality, and example SAT solvers perform well in verification or proof of inequality. Coupling of RE and SAT technique takes advantage of strong points of both RE and SAT and obtains a combined advantage, which improves circuit verification with reduced runtime complexity and increased capability such as capability to tackle NP-complete circuits efficiently.

Example embodiments solve the above-stated problems and/or overcome the inability of existing methods and devices in that prior knowledge of input and output boundaries is unnecessary. Coupling of RE and SAT technique in which proof of equality is left to RE such that a SAT solver only deals with proof of inequality and thus is avoided being trapped into an exponential process, when verifying arithmetic circuit. In contrast with existing methods in which a SAT solver is often trapped into an exponential process during handling or solving arithmetic modules with multipliers implemented, example embodiments improve verification effectiveness by avoiding a SAT solver proving equality that is generally beyond ability of the SAT solver. Example embodiments improve verification efficiency by reducing runtime complexity of a varication proves to polynomial time or even linear time. In one example embodiment, with same computer hardware, an example embodiment runs two 32-bit multipliers (Wallace vs Modified Booth) within 5 seconds regardless of their equality or inequality, while running SAT alone would take 10¹⁰ centuries. In one example embodiment, compared with two existing commercial tools, example methods runs at least 400 to 1400 times faster, and also solve 32% to 45% more cases (93% vs 61% or 48%).

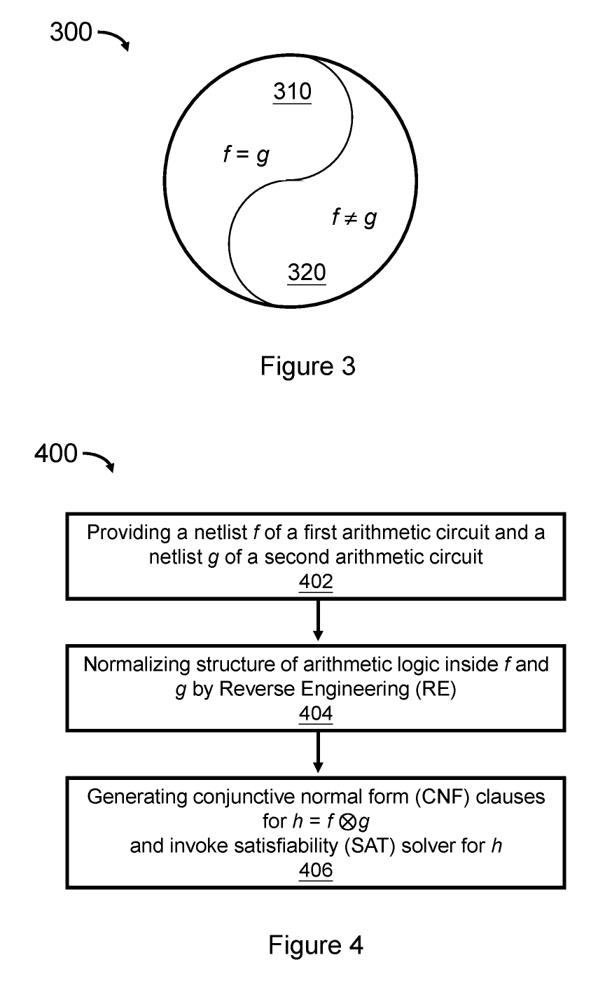

FIG. 3 shows a graph illustrating equivalence checking in accordance with an example embodiment. The graph 300 is illustrated as a circle that includes a first part 310 and a second part 320. By way of example, f represents a first multiplier, and g represents a second multiplier. The first part 310 represents a scenario when f=g, and the second part 320 represents a scenario when f≠g.

A SAT solver completes the equivalence checking between the two multipliers f and g in polynomial time when f≠g. However, it takes exponential time for the SAT solver when f=g because the SAT solver needs to check all possible input patterns which is exponential in nature.

For the scenario f=g, the equivalence checking can be completed in polynomial time if reverse engineering or structural-analysis based reverse engineering is applied, because in many circuits such as practical ICs, optimal designs of arithmetic circuit operators have been carefully studied and adopted designs or patterns are restricted to limited numbers in style. For example, different designs of a same arithmetic operator (such as a multiplier) share certain common structural property (so-called “structural DNA”), which is unique and differentiable from other arithmetic operators, such as an adder. Example embodiments utilize this property to find exact input/output (IO) boundary and thus complete equivalence checking fast (e.g. in linear time or near linear time). However, this property is not useful in proving inequality (e.g. f≠g) during equivalence checking because there could exist unlimited possibility of new unknown design.

Example embodiments provide technical solutions that reduce runtime complexity by coupling or combining reverse engineering and SAT techniques. By way of example, during an equivalence checking process, example embodiments leave the inequality proof (e.g. f≠g) to a SAT solver, which can run fast and can be finished in polynomial time, and let reverse engineering handle equality proof (e.g. f=g). Thus, the SAT solver is prevented from being trapped into unsatisfiable proof process in which it runs in exponential time or even “forever”.

Example embodiments work in a complementary way (or Complementary Greedy Coupling (CGC) approach, or Tai-Chi Coupling) efficiently for equivalence checking. Efficiency of circuit verification is significantly improved such that a much shorter time is required to complete the verification. Circuit verification that cannot be performed by a SAT solver alone (such as NP-complete circuits) can be executed fast by example embodiments. In addition, no prior knowledge of IO boundaries is required because example embodiments or methods can find exact IO boundaries efficiently by utilizing the so-called “structural DNA”.

In one example embodiment, runtime complexity is in linear time. By way of example, runtime complexity for an arithmetic circuitry verification is linear to a number of gates in the netlist f and the netlist g.

Example embodiment provides a technical solution that includes comparing a first netlist f of a first arithmetic circuit with a second netlist g of a second arithmetic circuit when f=g, and improving runtime complexity by conducting equivalence checking between the first netlist and the second netlist such that structural difference between the first netlist and the second netlist is minimized by reverse engineering before generating a conjunctive normal form (CNF) encoding that is solved by a SAT solver such that the arithmetic circuit verification is completed in polynomial time.

FIG. 4 shows a flow diagram in accordance with an example embodiment. The flow diagram 400 illustrates an example method that can be executed by a computer that incorporates software or an apparatus that incorporates such computer.

The example method, when executed by the computer, solves one or more existing technical problems as stated above in circuity industry by improving effectiveness and efficiency (such as reduced runtime complexity) for circuit verification. The example method also improves performance of the computer system that executes the example method by consuming less resource such as memory, processor.

Block 402 states providing a netlist f (or a first netlist) of a first arithmetic circuit and a netlist g (or a second netlist) of a second arithmetic circuit.

In some example embodiments, a first netlist or netlist f includes a first sub-circuit that implements a first sub-circuit formula, and a second netlist or netlist g includes a second sub-circuit that implements a second sub-circuit formula. For example, the first sub-circuit formula is (4A+3B)×C, and the second sub-circuit formula is 4A×C+3B×C.

Block 404 states performing reverse engineering to minimize the structural difference between the first netlist f and the second netlist g before generating a conjunctive normal form (CNF) encoding that is solved by a SAT solver. Reverse engineering includes operator macro mapping, operand mapping, and formula equivalence checking and normalization which will be discussed later.

By way of example, operator macros are extracted from the netlist f and the netlist g to obtain a plurality of extracted operator macros, and the plurality of extracted operator macros are replaced with operator macro symbols or equivalent operator symbols.

Equivalence of the first sub-circuit formula and the second sub-circuit formula are then evaluated to determine that a first part of the first sub-circuit formula is equivalent to a second part of the second sub-circuit formula, and then the first part of the first sub-circuit formula in the netlist f and the second part of the second sub-circuit formula in the netlist g are replaced with a same netlist pattern. The formulae equivalence checking is achieved by existing word-level checking algorithm that formula with identical function can be expressed in a canonical representation.

Block 406 states that a CNF encoding h=f [symbol] g is generated or created, and the CNF encoding is solved by a SAT solver, wherein [symbol] represents the exclusive-or (XOR) operation of netlist f and g. Finally, equivalence checking between the netlist f and the netlist g is conducted by invoking SAT solver to check the satisfiability of h.

In the example embodiment, as the equivalent arithmetic formula parts are already normalized to the same pattern in both netlists, the CNF encoding h would be extremely trivial for a SAT solver to avoid being trapped into an exponential process and thus can be solved in a few seconds for example.

As an example, two equivalent functions represented in an identical implementation are solved by a SAT solver in polynomial time. For example, a SAT solver traverses the two equivalent functions and generates CNF clauses in topological order. Since the two equivalent functions are exactly in a same implementation form, the SAT solver merges every pair CNF clauses which have same inputs and sub functions. The result is obtained by one traversal in polynomial time.

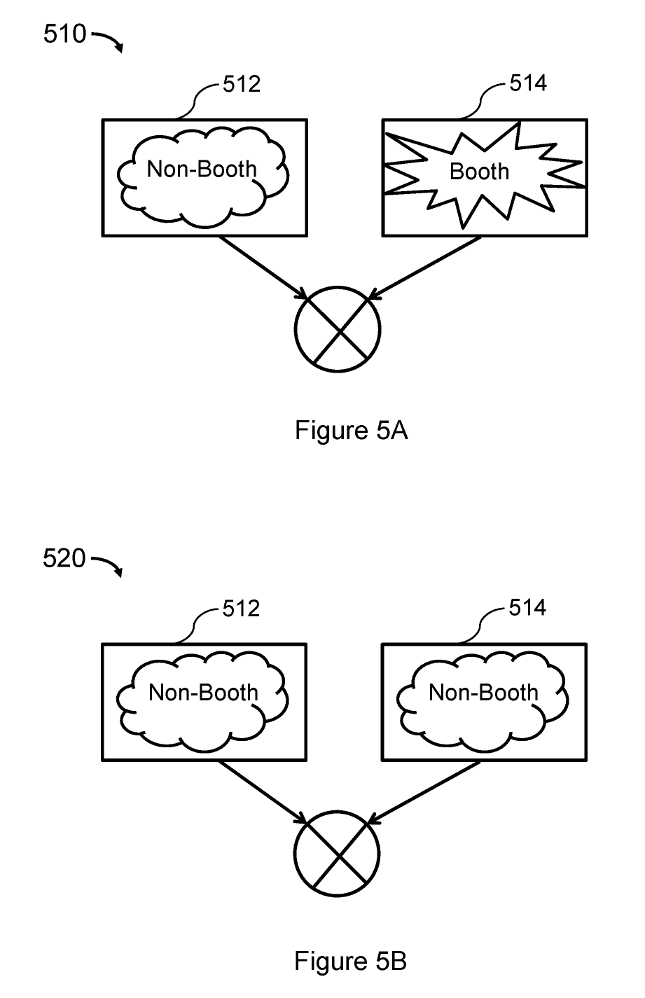

FIGS. 5A-5B show two graphs illustrating a normalization process in accordance with an example embodiment. The graph 510 shows two netlists, netlist 512 and netlist 514, that are compared or on which equivalence checking are performed. The netlist 512 includes a Non-Booth multiplier and the netlist 514 includes a Booth multiplier.

By way of example, during the equivalence checking, as a first step, the multipliers are identified. Then the Non-Booth multiplier in the netlist 514 is restructured to a Non-Booth style and its formula is rewritten to obtain a Non-Booth multiplier in the netlist 514 (see FIG. 5B) such that structural difference between the two netlists are reduced to minimal (i.e. internal equivalence are maximized) to speed up equivalence check. In an example embodiment, the resynthesized or restricted netlists are transformed into CNF clauses to be solved by a SAT solver.

Example methods improve computer performance by reducing memory usage and processing capacity by avoiding the SAT solver being trapped into the exponential time and by reducing runtime complexity for the arithmetic circuitry verification. In an example embodiment, the runtime complexity is linear with a number of gates in the netlist f and the netlist g. By way of example, a large number of internal equivalent points are easily located in the CNF encoding or CNF form or CNF clauses, and thus the SAT solver runs fast. For example, it takes only five seconds on average to pre-process and solve when comparing a Wallace multiplier with a Booth multiplier (each is of 32-bit).

By way of example, example methods extract multipliers designed by different ways (such as Array/Adder-tree multipliers, Carry Save Adders (CSAs), Wallace, modified or regular Booth) composed of one-bit adders (half adders and full adders) under an O(n²) complexity bound, where n is the multiplier's bit-width, and the runtime is linear or almost linear to the number of gates used for the multipliers. By way of example, example methods efficiently extract other common arithmetic macros (such as multiplexers, adders, large XOR trees) with various design variations (e.g. CLA adder, Ripple adder, etc.) from a netlist.

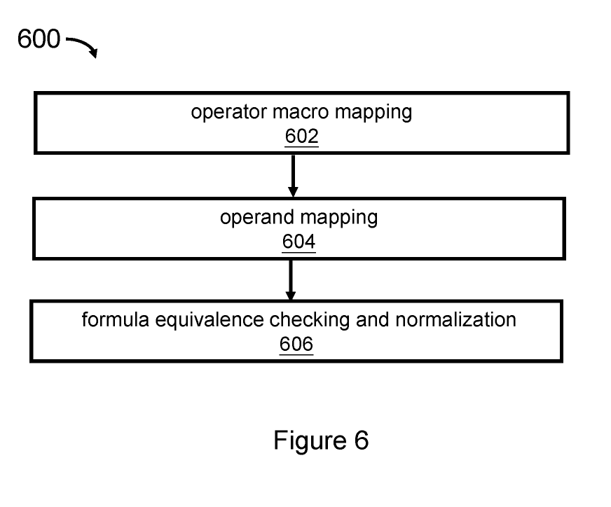

FIG. 6 shows a flow diagram illustrating reverse engineering of example method. As an example, FIG. 6 is the detailed flow of Block 404 in FIG. 4.

The flow of reverse engineering in the example method is illustrated in the flow diagram 600.

Block 602 states conducting operator macro mapping. As an example, example methods compare a first netlist or netlist f of a first arithmetic circuit and a second netlist or netlist g of a second arithmetic circuit. The netlist f includes a first sub-circuit that implements a first sub-circuit formula, and the netlist g includes a second sub-circuit that implements a second sub-circuit formula. Operator macro mapping is performed such that function of the first sub-circuit and function of the second sub-circuit are identified.

In an example embodiment, both non-Booth multipliers and Booth multipliers are regarded as a structure of 1-bit half or full adders. A 1-bit half or full adder is thus considered as an atomic unit of the implementation, and a macro is partitioned into a number of 1-bit adders. Every input signal of a 1-bit adder in a multiplier implementation is either a partial product or an output (carry or sum) of another 1-bit adder. By way of example, the process to map adders, multipliers and their combinations can therefore be done and constructed from a basic structure: 1-bit adders.

In one example embodiment, a netlist is traversed to identify all 1-bit half adders and 1-bit full adders. Then the 1-bit half adders and the 1-bit full adders are connected to form one or more 1-bit adder trees by a plurality of sum signals of the 1-bit half adders and the 1-bit full adders. By way of example, each 1-bit adder-tree represents an addition of signals having same bit-weight. Carry signals are also connected as tree structure. By means of carry signals, the 1-bit adder trees are then connected to form a 1-bit adder-forest, which, for example, represents a candidate arithmetic macro. Weights of the macro output bits and input bits are then determined according to the boundary of the 1-bit adder forest. By way of example, the output boundary of the forest is formed by the output of every 1-bit adder tree. The input boundary of the forest is formed by the partial products of multipliers or the input bits of adders.

In one example embodiment, complexity of constructing adder trees and forest is linear with respect to circuit size such as the number of gates in a circuit. Thus, the partial products for each bit-weight is identified in linear time.

In one example embodiment, complexity of determining input boundary of an n-bit multiplier (such as Booth and Non-Booth) is O(n²) and is O(circuit size). By way of example, the number of partial products of an n-bit Non-Booth multiplier is n×n, and that of an n-bit Booth multiplier is

$${ }^{⌈ \frac{n}{2} ⌉ \times ( n} + 1 ) .$$

After constructing adder-trees and forest, the partial products for each bit-weight are obtained. Input boundary of the multiplier is then determined by visiting the partial products in the order of their corresponding bit-weights. Thus, complexity of input boundary discovery is linear with the number of partial products, or is O(n²) with respect to the multiplier's bit-width.

The unique structure of the 1-bit adder forest (e.g. the number of 1-bit adder trees, the size of each 1-bit adder tree, the way that the 1-bit adder trees are connected, and the types of signals lying on the boundaries) is used to characterize a macro. Hence, the type of the candidate arithmetic macro is figured out instantly once the 1-bit adder forest is constructed.

In one example embodiment, complexity of mapping 1-bit adder based multipliers (such as array, Non-Booth and Booth) using example methods grows linearly with circuit size (such as the number of gates in a circuit). In an example embodiment, arithmetic formulae used in practical circuits are relatively simple, complexity of formula manipulation and operand mapping can be considered as a constant, and complexity of macro normalization is thus linear with circuit size. Overall complexity of example methods is therefore linear.

Block 604 stats conducting operant mapping such that the first sub-circuit formula and the second sub-circuit formula are identified.

In a process of identifying or extracting a macro or operator macro, the corresponding formula is identified. For example, when comparing two macros whose formulae are (A+B)×C and E×(F+G) respectively, the first step is to determine relationships between variables in these formulae.

In an example embodiment, to conduct operand mapping, all primary input are encoded. For example, four primary inputs a, b, c and d can be encoded as a 4-bit number sequence 0000-1111. Then the mapping signature value of a bit is calculated by the encode value of the primary inputs driving the bit. For example, if the bit is driven by primary input b and d, then its mapping signature is 0101. For example, for an adder, the operand bits of all weights should be mapped according to their sorted mapping signature values, while for a multiplier, only the operands need to be mapped.

By way of example, for a macro with m operands of n-bit words, the complexity of an adder mapping is O(nmlogm) and O(mlogm) for a multiplier mapping. As m is usually quite small, the cost is constant or nearly a constant or close to O(n).

Block 606 states conducting formula equivalence checking and normalization. For example, structural difference between the netlist f and the netlist g is minimized such that the first sub-circuit and the second sub-circuit are re-implemented to have a same structure if the function of the first sub-circuit is same as the function of the second sub-circuit. The formulae equivalence checking is achieved by existing word-level checking algorithm that formula with identical function can be expressed in canonical representation.

By way of example, if there are no more logics left outside the macros, the equivalence checking process is completed. Otherwise, structural difference between functionally equivalent macros is further reduced by repeating the formula equivalence checking and normalization process.

In one example embodiment, to perform an efficient macro normalization, after knowing the function formulae of macros, a standard synthesis procedure and a standard formula expression for each common macro type are predefined or provided and each recognized macro is transformed to its predefined canonical form. For example, a non-Booth style is chosen as the standard formula expression or standard style to synthesize multipliers, as shown in FIGS. 5A-5B. Then the CNF encoding of new netlists is solved by a SAT solver quickly.

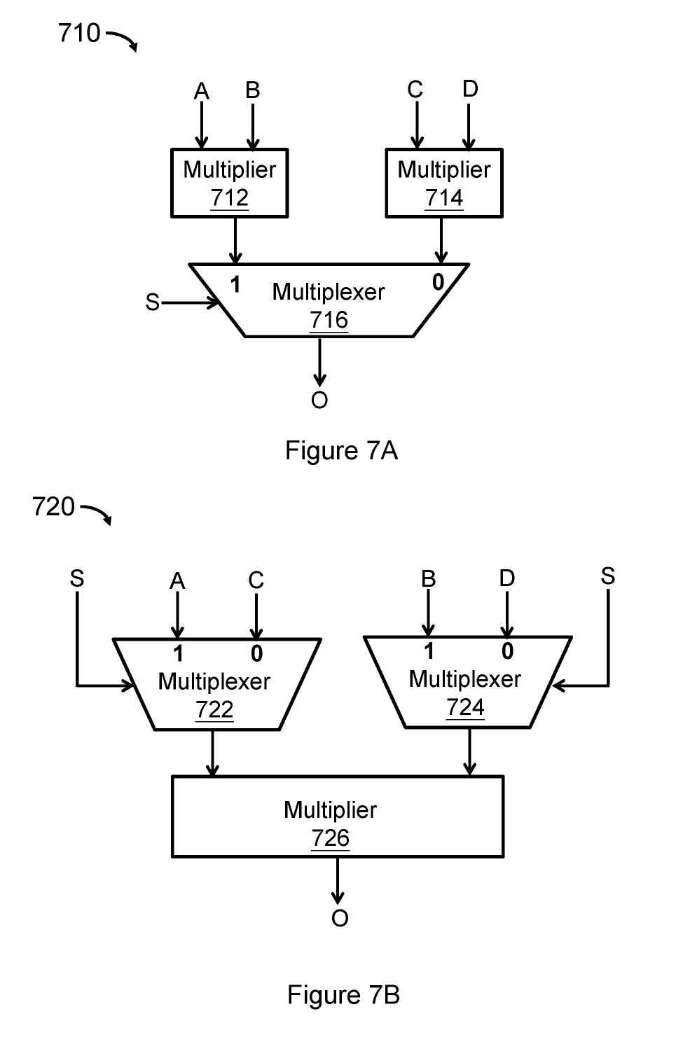

In some example embodiments, example methods handle other data-path equivalent patterns such as MUX(s,(A×B):(C×D))=MUX(s,(A:C))×MUX(s,(B:D)) as shown in FIGS. 7A-7B.

FIGS. 7A-7B show macros formed by multiplexers and multipliers in accordance with an example embodiment. FIG. 7A shows a graph 710 that includes a multiplier 712, a multiplier 714, and a multiplexer 716. FIG. 7B shows a graph 720 that includes a multiplexer 722, a multiplexer 724, and a multiplier 726.

The implementation in the graph 710 is illustrated as MUX(s,(A×B):(C×D)), and the implementation in the graph 720 is illustrated as MUX(s,(A:C))×MUX(s,(B:D)). The two implementations are equivalent functionally, but have different structural pattern or style.

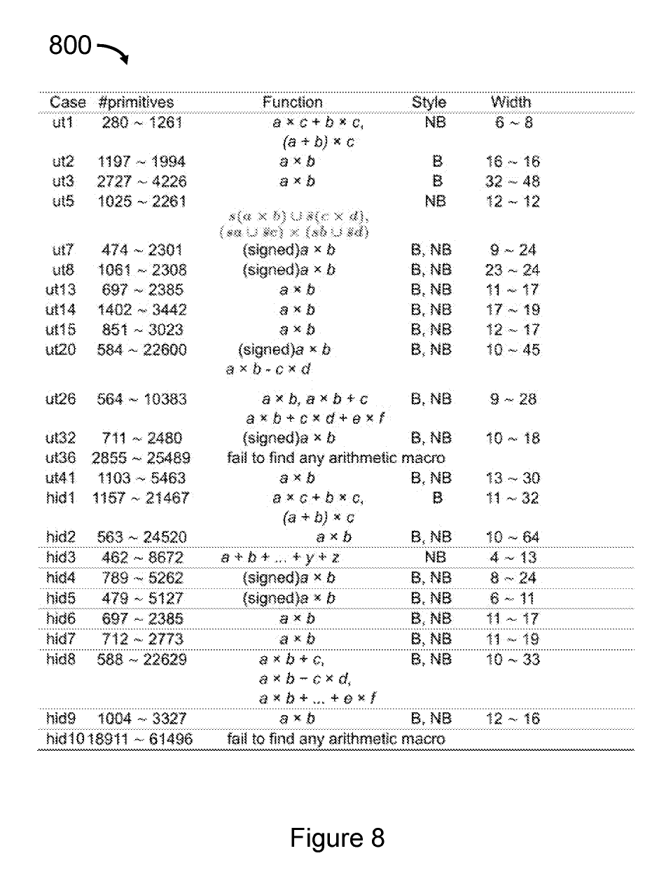

FIG. 8 shows a table illustrating characteristics of benchmarks in accordance with an example embodiment. In the table 800, in the column of “Style”, B represents Booth multiplier, and NB represents Non-Booth multiplier. As shown, besides multiplication, some more complicated arithmetic functions (see the column of “Function” in the table 800) also exist in the benchmarks.

By way of example, each of the benchmarks is a gate-level single-output combinational circuit. The benchmarks are divided into 24 test case suites. Each suite includes three sample circuits, and ten test circuits are synthesized using a same design style. All circuits in a same suite implement similar arithmetic functions which only differ in their operands' bit-widths.

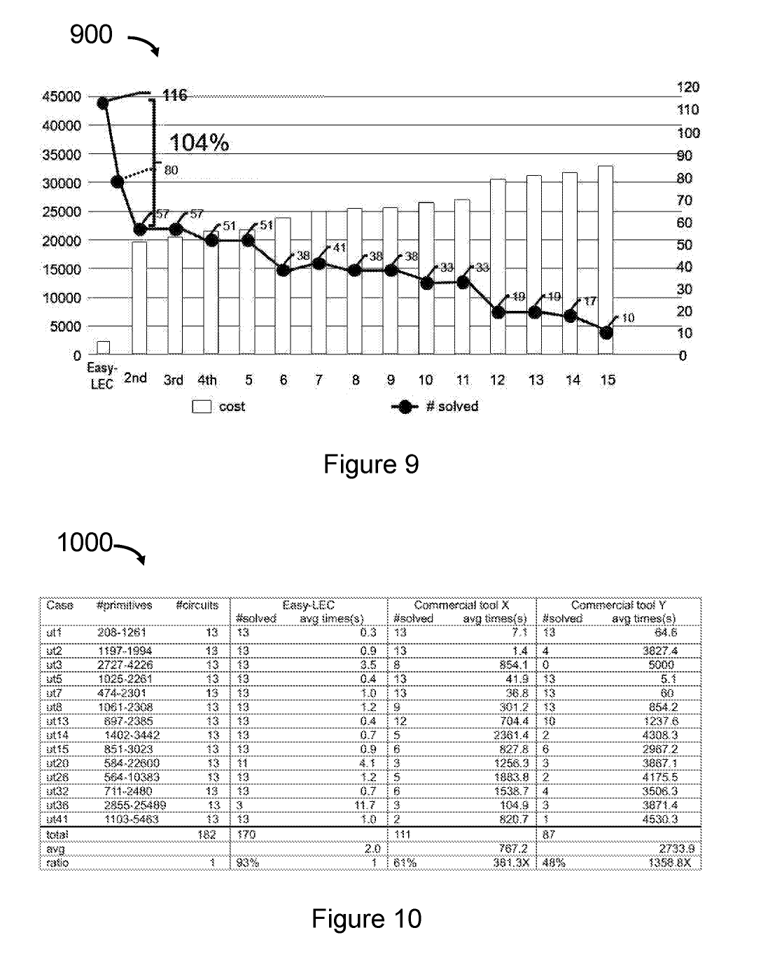

FIG. 9 shows a graph illustrating comparison between example methods and existing methods in accordance with an example embodiment.

As shown in FIG. 9, an example method, which is represented by Easy-LEC, is compared with another fourteen existing methods.

In FIG. 9, “cost” represents sum of cost (i.e. weighted CNF encoding time plus SAT solving time) of total 120 circuits (10 test circuits each from 12 cases). “#solved” represents the number of solved circuits for each method.

Numbers on left vertical axis in FIG. 9 represents cost (unit: seconds), and numbers on right vertical axis represents number of circuits in terms of cost and numbers of circuits solved. As shown, the example method (Easy-LEC) ranks first. For example, the example method has a cost which is ⅛ of that for No. 2 ranked method. In addition, the example method solves more problems (116 versus 57 in number or 97% versus 49%).

FIG. 10 shows a table illustrating comparison between example methods and two existing commercial tools in accordance with an example embodiment.

The table 1000 compares example methods, which are represented by Easy-LEC, with two commercial logic equivalence checking tools X and Y. The comparison is performed on 14 open suits (ut1 - ut41). For each suit, all the 13 circuits including three sample circuits and ten test circuits are tested. For each circuit, each tool terminates either after solving a SAT problem, or reaching time limit. The two commercial tools X and Y abort after running several thousands of seconds.

In the table 1000, Columns “#solved” list the number of solved circuits. Columns “avg times” list average runtime for each circuit regardless of whether it is solved or not. As shown in the table 1000, for all test suites except ut36 whose arithmetic logics fails to be extracted, example methods solve most of the test circuits within seconds. In contrast, both commercial tools X and Y can only totally solve cases with primitive gates but not complex arithmetic logics (e.g. ut1, ut2, ut5, and ut7 for X, ut1, ut5, ut7, and ut8 for Y).

For these 182 open cases as shown in the table 1000, example methods solve 93% circuits under a SAT time limit of 3 seconds per case, which is much better than the two commercial tools (61% by X and 48% by Y) under a SAT time limit of 5000 seconds per case. Example methods are at least 381 times faster than the commercial tool X and 1358 times faster than the commercial tool Y

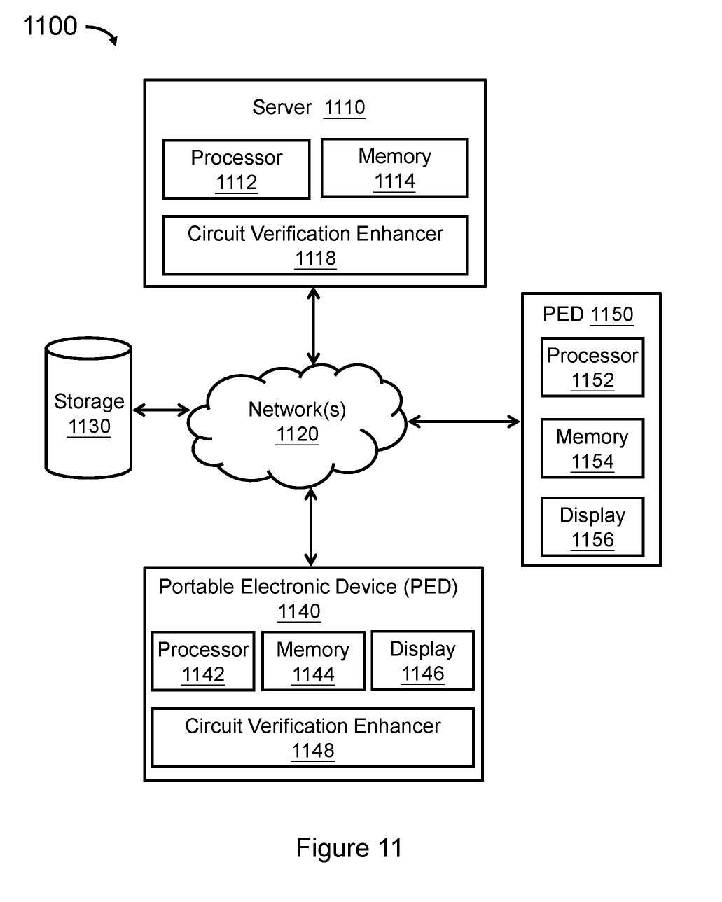

FIG. 11 shows a computer system or electronic system in accordance with an example embodiment. The computer system 1100 includes one or more computers or electronic devices (such as one or more servers) 1110 that includes a processor or processing unit 1112 (such as one or more processors, microprocessors, and/or microcontrollers), one or more components of computer readable medium (CRM) or memory 1114, and a circuit verification enhancer 1118.

The memory 1114 stores instructions that when executed cause the processor 1112 to execute a method discussed herein and/or one or more blocks discussed herein. The circuit verification enhancer 1118 is example of specialized hardware and/or software that assist in improving performance of a computer and/or execution of a method discussed herein and/or one or more blocks discussed herein. Example functions of a circuit verification enhancer are discussed in connection with FIGS. 4 and 6.

In an example embodiment, the computer system 1100 includes a storage or memory 1130, a portable electronic device or PED 1140 in communication over one or more networks 1120.

The storage 1130 can include one or more of memory or databases that store one or more of image files, audio files, video files, software applications, and other information discussed herein. By way of example, the storage 1130 store image, instructions or software application that are retrieved by the server 1110 over the network 1120 such that a method discussed herein and/or one or more blocks discussed herein are executed.

The PED 1140 includes a processor or processing unit 1142 (such as one or more processors, microprocessors, and/or microcontrollers), one or more components of computer readable medium (CRM) or memory 1144, one or more displays 1146, and a circuit verification enhancer 1148.

The PED 1140 can execute a method discussed herein and/or one or more blocks discussed herein and display an image or a file (such as a netlist) for review. Alternatively or additionally, the PED 1140 can retrieve files such as images and files and software instructions from the storage 1130 over the network 1120 and execute a method discussed herein and/or one or more blocks discussed herein.

In an example embodiment, the computer system 1100 includes a PED 1150 that includes a processor or processing unit 1152 (such as one or more processors, microprocessors, and/or microcontrollers), one or more components of computer readable medium (CRM) or memory 1154, and one or more displays 1156.

By way of example, the PED 1150 communicates with the server 1110 and/or the storage 1130 over the network 1120 such that a method discussed herein and/or one or more blocks discussed herein is executed either by the server 1110 and results are sent back to the PED 1150 for output, storage and review.

The network 1120 can include one or more of a cellular network, a public switch telephone network, the Internet, a local area network (LAN), a wide area network (WAN), a metropolitan area network (MAN), a personal area network (PAN), home area network (HAM), and other public and/or private networks. Additionally, the electronic devices need not communicate with each other through a network. As one example, electronic devices can couple together via one or more wires, such as a direct wired-connection. As another example, electronic devices can communicate directly through a wireless protocol, such as Bluetooth, near field communication (NFC), or other wireless communication protocol.

In some example embodiments, the methods illustrated herein and data and instructions associated therewith, are stored in respective storage devices that are implemented as non-transitory computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed and removable disks; other magnetic media including tape; optical media such as Compact Disks (CDs) or

Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to a manufactured single component or multiple components.

Blocks and/or methods discussed herein can be executed a processor, controller, and other hardware discussed herein. Furthermore, blocks and/or methods discussed herein can be executed automatically with or without instruction from a user.

The methods in accordance with example embodiments are provided as examples, and examples from one method should not be construed to limit examples from another method. Figures and other information show example data and example structures; other data and other database structures can be implemented with example embodiments. Further, methods discussed within different figures can be added to or exchanged with methods in other figures. Further yet, specific numerical data values (such as specific quantities, numbers, categories, etc.) or other specific information should be interpreted as illustrative for discussing example embodiments. Such specific information is not provided to limit example embodiments.

As used herein, the term “arithmetic circuit” refers to a circuit implementing arithmetic function such as adders, multipliers and their combinations.

As used herein, the term “exponential time” refers to running time for an algorithm or a method is upper bounded by 2ⁿ, wherein n is size of the input for the algorithm.

As used herein, the term “polynomial time” refers to running time for an algorithm or a method is upper bounded by a polynomial expression in the size of the input for the algorithm.

As used herein, the term “linear time” refers to running time for an algorithm or a method increases linearly with the size of the input for the algorithm.

What is claimed is:

1. A method executed by a computer system to enable arithmetic circuit verification with improved runtime complexity, the method comprising:
providing a netlist f of a first arithmetic circuit and a netlist g of a second arithmetic circuit; and
improving, by the computer system, the runtime complexity by conducting equivalence checking between the netlist f and the netlist g such that structural difference between the netlist f and the netlist g is minimized by reverse engineering (RE) before generating a conjunctive normal form (CNF) encoding that is solved by a satisfiability (SAT) solver such that the arithmetic circuit verification is completed in polynomial time rather than in exponential time.

2. The method of claim 1, wherein the runtime complexity for the arithmetic circuitry verification is linear to a number of gates in the netlist f and the netlist g.

3. The method of claim 1, wherein the netlist f includes a first sub-circuit that implements a first sub-circuit formula, and the netlist g includes a second sub-circuit that implements a second sub-circuit formula,
wherein the method improves arithmetic circuit verification by reverse engineering that comprises:
conducting, by the computer system, operator macro mapping such that function of the first sub-circuit and function of the second sub-circuit are identified;
conducting, by the computer system, operand mapping such that the first sub-circuit formula and the second sub-circuit formula are identified; and
minimizing, by the computer system, the structural difference between the netlist f and the netlist g by conducting formula equivalence checking and normalization such that the first sub-circuit and the second sub-circuit are re-implemented to have a same structure if the function of the first sub-circuit is same as the function of the second sub-circuit.

4. The method of claim 1, wherein the netlist f includes a non-Booth multiplier, and the netlist g includes a Booth multiplier,
wherein the method improves arithmetic circuit verification by reverse engineering that comprises:
identifying, by the computer system, the non-Booth multiplier in the netlist f and the Booth multiplier in the netlist g;
converting the Booth multiplier in the netlist g into a non-Booth multiplier to obtain a converted non-Booth multiplier; and
improving, by the computer system, the equivalence checking by rewriting the non-Booth multiplier in the netlist f and the converted non-Booth multiplier in the netlist g to minimize structural difference between the netlist f and the netlist g such that the equivalence checking is speeded up.

5. The method of claim 3, wherein the operator mapping in the reverse engineering comprises:
conducting, by the computer system, operator macro mapping to obtain an extracted operator macro that includes a multiplier, wherein implementation of the multiplier is one of a non-Booth Wallace tree and a Booth multiplier.

6. The method of claim 5, wherein the operator mapping for each of the netlist f and the netlist g comprises:
traversing, by the computer system, the netlist to identify a plurality of 1-bit half adders and a plurality of 1-bit full adders;
connecting, by the computer system, the 1-bit half adders and the 1-bit full adders to form one or more 1-bit adder trees through a plurality of sum signals of the 1-bit half adders and the 1-bit full adders, wherein carry signals are also connected in tree structure;
connecting, by the computer system, the one or more 1-bit adder trees and carry trees to form a 1-bit adder forest; and
determining, by the computer system and based on boundary of the 1-bit adder forest, weights of macro input bits and output bits.

7. The method of claim 3, wherein the operand mapping comprises:
encoding, by the computer system, a plurality of primary input; and
calculating, by the computer system, a mapping signature value of a bit by a encode value of the primary input driving the bit to obtain a plurality of mapping signature values.

8. The method of claim 7, wherein operand bits of weights are mapped according to the plurality of mapping signature values that are sorted.

9. A computer system that improves arithmetic circuit verification with reduced runtime complexity, the computer system comprising:
a processor;
a non-transitory computer-readable medium having stored therein instructions that when executed cause the processor to:
receive a netlist f of a first arithmetic circuit and a netlist g of a second arithmetic circuit; and
reduce the runtime complexity by conducting equivalence checking between the netlist f and the netlist g such that structural difference between the netlist f and the netlist g is minimized by reverse engineering (RE) before generating a conjunctive normal form (CNF) encoding that is solved by a satisfiability (SAT) solver such that the arithmetic circuit verification is completed in polynomial time rather than in exponential time.

10. The computer system of claim 9, wherein the runtime complexity for the arithmetic circuitry verification is linear to a number of gates in the netlist f and the netlist g.

11. The computer system of claim 9, wherein the netlist f includes a first sub-circuit that implements a first sub-circuit formula, and the netlist g includes a second sub-circuit that implements a second sub-circuit formula,
wherein the instructions when executed cause the processor to:
conduct operator macro mapping such that function of the first sub-circuit and function of the second sub-circuit are identified;
conduct operand mapping such that the first sub-circuit formula and the second sub-circuit formula are identified; and
minimize the structural difference between the netlist f and the netlist g by conducting formula equivalence checking and normalization such that the first sub-circuit and the second sub-circuit are re-implemented to have a same structure if the function of the first sub-circuit is same as the function of the second sub-circuit.

12. The computer system of claim 9, wherein the netlist f includes a non-Booth multiplier, and the netlist g includes a Booth multiplier,
wherein the instructions when executed cause the processor to:
identify the non-Booth multiplier in the netlist f and the Booth multiplier in the netlist g;
convert the Booth multiplier in the netlist g into a non-Booth multiplier to obtain a converted non-Booth multiplier; and
improve the equivalence checking by rewriting the non-Booth multiplier in the netlist f and the converted non-Booth multiplier in the netlist g to minimize structural difference between the netlist f and the netlist g such that the equivalence checking is speeded up.

13. The computer system of claim 9, wherein the instructions when executed cause the processor to:
conduct operator macro mapping to obtain an extracted operator macro that includes a multiplier, wherein implementation of the multiplier is one of a non-Booth Wallace tree and a Booth multiplier.

14. The computer system of claim 9, wherein the instructions when executed cause the processor to, for each of the netlist f and the netlist g:
traverse the netlist to identify a plurality of 1-bit half adders and a plurality of 1-bit full adders;
connect the 1-bit half adders and the 1-bit full adders to form one or more 1-bit adder trees through a plurality of sum signals of the 1-bit half adders and the 1-bit full adders, wherein carry signals are also connected in tree structure;
connect the one or more 1-bit adder trees and carry trees to form a 1-bit adder forest; and
determine, based on boundary of the 1-bit adder forest, weights of macro input bits and output bits.

15. The computer system of claim 9, wherein the instructions when executed cause the processor to:
encode a plurality of primary input; and
calculate a mapping signature value of a bit by a encode value of the primary input driving the bit to obtain a plurality of mapping signature values.

16. The computer system of claim 15, wherein operand bits of weights are mapped according to the plurality of mapping signature values that are sorted.

17. A computer-implemented method that improves performance of a computer system for arithmetic circuit verification, the method comprising:
receiving, by the computer system, a netlist f of a first arithmetic circuit and a netlist g of a second arithmetic circuit;
improving performance of the computer system by reducing, with equivalence checking, memory usage of the computer system by minimizing structural difference using reverse engineering (RE) between the netlist f and the netlist g such that a conjunctive normal form (CNF) encoding is created and is solved by a satisfiability (SAT) solver in polynomial time rather than in exponential time.

18. The method of claim 17, wherein runtime complexity for the arithmetic circuitry verification is linear to a number of gates in the netlist f and the netlist g such that the memory usage of the computer system is reduced.

19. The method of claim 17, wherein the netlist f includes a first sub-circuit that implements a first sub-circuit formula, and the netlist g includes a second sub-circuit that implements a second sub-circuit formula;
wherein the method improving the performance of the computer system by reverse engineering that comprises:
conducting, by the computer system, operator macro mapping such that function of the first sub-circuit and function of the second sub-circuit are identified;
conducting, by the computer system, operand mapping such that the first sub-circuit formula and the second sub-circuit formula are identified; and
minimizing, by the computer system, the structural difference between the netlist f and the netlist g by conducting formula equivalence checking and normalization such that the first sub-circuit and the second sub-circuit are re-implemented to have a same structure if the function of the first sub-circuit is same as the function of the second sub-circuit.

20. The method of claim 17, wherein the netlist f includes a first sub-circuit that implements a first sub-circuit formula, and the netlist g includes a second sub-circuit that implements a second sub-circuit formula,
wherein the method further comprises:
extracting, by the computer system, operator macros from the netlist f and the netlist g to obtain a plurality of extracted operator macros,
replacing, by the computer system, the plurality of extracted operator macros with operator macro symbols;
evaluating, by the computer system, equivalence of the first sub-circuit formula and the second sub-circuit formula to determine that a first part of the first sub-circuit formula is equivalent to a second part of the second sub-circuit formula;
replacing, by the computer system, the first part of the first sub-circuit formula in the netlist f and the second part of the second sub-circuit formula in the netlist g with a same netlist pattern; and
if the netlist f and the netlist g are equivalent,
generating, by the computer system, the CNF encoding h=f [symbol] g; and
solving, by the computer system and with the SAT solver, the CNF encoding,
wherein the memory usage of the computer system is reduced by avoiding the SAT solver being trapped into the exponential time and by making runtime complexity for the arithmetic circuitry verification be linear to a number of gates in the netlist f and the netlist g.
